(19) United States
(12) Patent Application Publication
(10) Pub. No.: US 2006/0098442 A1
(43) Pub. Date: May 11, 2006

(54) Removable LED lampholder

(76) Inventor: Jing Jing Yu, Vancouver (CA)

Correspondence Address: Jing Jing Yu, 504 - 5411 Vine Street, Vancouver, BC, V6M 327, CA

(21) Appl. No.: 10/984,651

(22) Filed: Nov. 10, 2004

(51) Int. Cl. F21V 15/00

(52) U.S. Cl. 362/378

(57) ABSTRACT

A removable LED (light emitting diode) lampholder comprises a keyed LED base and a socket. The keyed LED base has a hollow body and is used to hold and fix an LED bulb. The socket houses an LED base and two electrical wire terminals. Each of the two terminals can connect to one or two electrical wires through the bottom side of the socket. A keyed LED base and a correspondingly-shaped socket are well matched in shape and size, so that the LED base can plug into the socket only in one orientation from the top end of the socket, and fix firmly inside the socket. The base can be pulled out from the socket when needed. The two LED pins bent over tow opposite outer sides of a LED base will firmly touch the two electrical terminals when the base is plugged in the socket, and thus ensure a reliable electrical connection between a pin and a terminal.

### BACKGROUND OF INVENTION

Incandescent lights work in a full cycle of sinusoid AC voltage, so there is no concern about their polarities when connecting them to either a DC or an AC power line. An LED light, however, being a diode, conducts current only in one direction, i.e. from its anode side to cathode side. To work properly, an LED light must be connected with a right polarity in a DC power line, where a positive voltage must apply from its anode to its cathode. When an LED is used in an AC circuit, it conducts current only for half cycle of the AC voltage, i.e. only when it has a positive voltage offset from its anode end to its cathode end.

In another case, where two or more LEDs are connected in series, all LEDs must be connected in a same polarity direction, i.e. the anode of the second LED must be connected to the cathode of the first LED, and the anode of the third LED must be connected to the cathode of second LED, and so on. Otherwise, no current can flow through the series circuit, where one or more LEDs are connected in an opposite polarity direction with the rest LEDs.

Therefore, keyed lampholders are needed for LED lights which are connected in a series configuration or are used in a DC power line to ensure correct polarity and enable easy lamp installation and replacement.

### SUMMARY OF THE INVENTION

### Field of Invention

The present invention relates to lampholder, and more specifically to LED light lampholder.

A keyed LED lampholder is provided to ensure right polarity when installing or replacing an LED bulb in a series configured circuit or in a DC circuit. The LED lampholder comprises a keyed LED base and a correspondingly shaped socket. An LED light bulb can be inserted and fixed in the cylinder-shaped installation section on the upper body of the base. The two pins of the LED light pass downward through the hollow body of the base, and come out through two small holes on the bottom of the base, then bend upward against two opposite outer sides of the base lower body. Two electrical terminals can be inserted and fixed respectively in a pair of shallow slots on the inner wall of the socket. Each electrical terminal can connect to one or two electrical wires through the bottom side of the socket. The keyed base and the correspondingly shaped socket are well matched in both shape and size so that, when the base is plugged into the socket in the correct direction from the socket top side, it, along with an installed LED bulb, fixes firmly inside the socket, where the housing of the socket will house the key of the base; and the first of two LED pins bent on the outer sides of the base lower part will firmly touch the first electrical terminal, and the second LED pin will firmly touch the second terminal, a reliable electrical connection is thus obtained between a pin and a terminal. As a result, a current from a power source can be supplied to the LED bulb via the electrical wires, the two terminals and the two LED pins. The LED base along with the LED bulb can be pulled out straight from the socket and plugged in again when replacing the LED bulb. Moreover, one or two wires can connect to each terminal at the same time, and thus enable flexible wiring and circuit configuration.

### BRIEF DESCRIPTION OF THE DRAWINGS

FIG. 1, FIG. 2, FIG. 3 and FIG. 4 show different perspective views of an LED base according to the invention.

FIG. 5 is a perspective view of an LED bulb and an LED base in an installation process.

FIG. 6 is a perspective view of an LED base with an installed LED bulb according to the invention.

FIG. 7 and FIG. 8 are different perspective views of a socket and a wedge according to the invention.

FIG. 9 shows two electrical terminals according to the invention.

FIG. 10 is a perspective view of a socket with two electrical terminals and a wedge installed inside according to the invention.

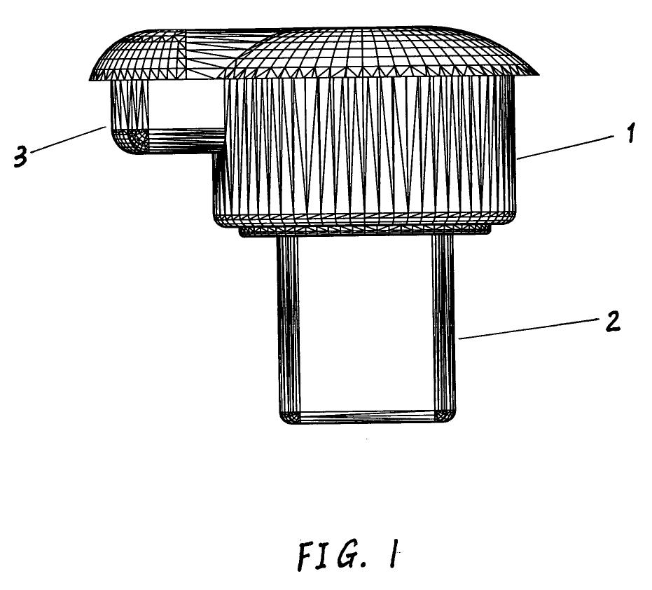

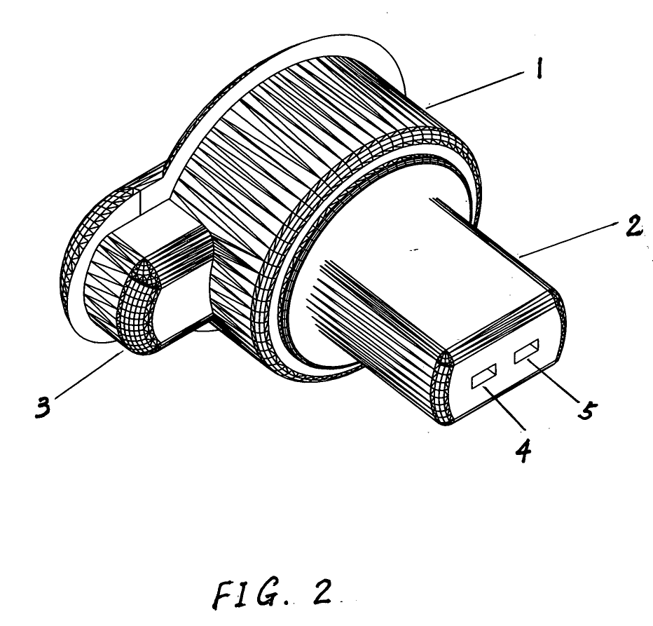

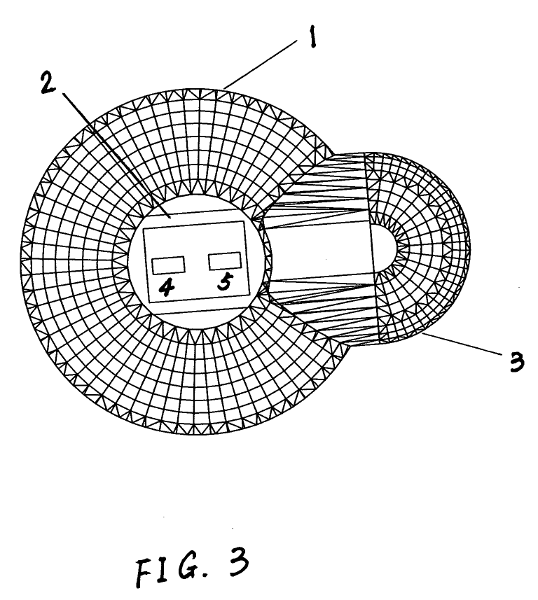

FIG. 1 is another perspective view of a socket according to the invention.

FIG. 12 is a perspective view of a base with an installed LED bulb, and a socket in a process of installation according to the invention.

FIG. 13 is a cross-section view of a socket, a base with an installed LED bulb according to the invention.

FIG. 14 and FIG. 15 are perspective views of a lampholder with an LED bulb installed according to the invention.

### DETAILED DESCRIPTION OF THE INVENTION

For an LED base as shown in FIG. 1, FIG. 2, FIG. 3 and FIG. 4, the upper body of a base is a hollow cylinder 1, and the lower body of a base is a hollow rectangular cube 2. The upper and lower bodies are molded into a single body.

As shown in these figures, a protrusion 3, namely the “key” of a base, is built on one side of the cylinder section 1 with the protrusion top side being at the same horizontal level with the cylinder top side. As shown in FIG. 2, there are two going-through holes 4 and 5 on the bottom of the rectangular cube 2 for passing two LED pins.

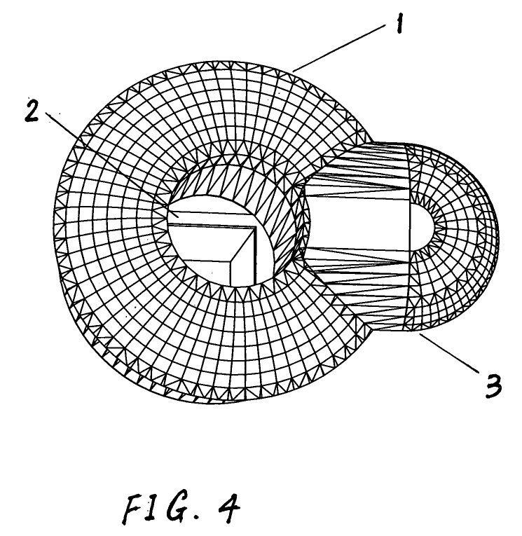

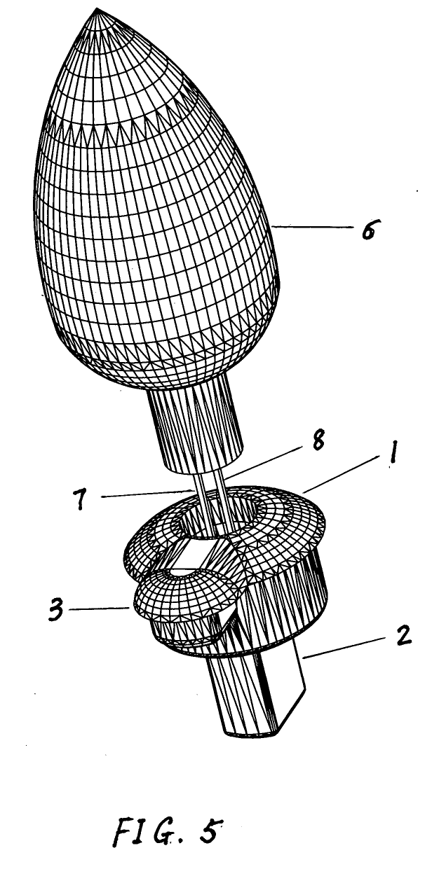

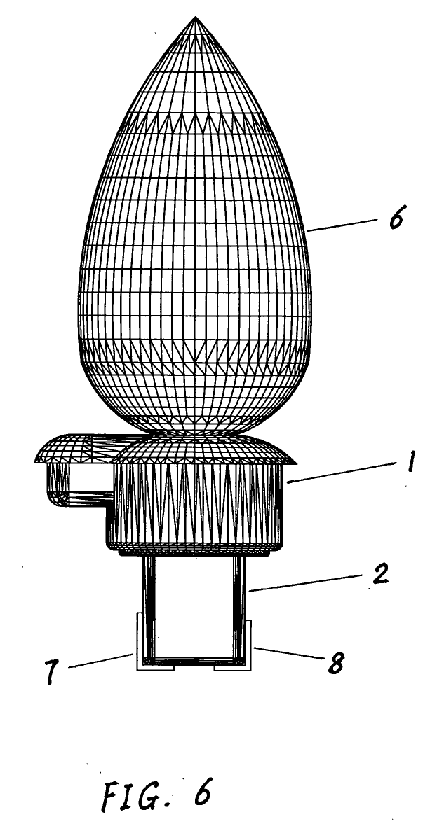

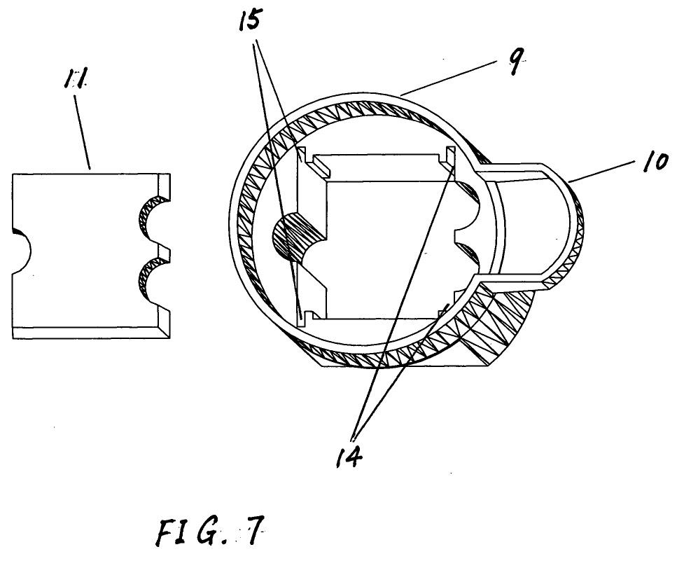

As shown in FIG. 5 and FIG. 6, an LED bulb 6 can insert into the LED base cylinder section 1 from the base top end and fix in the cylinder section 1. The two LED pins 7 and 8 will pass through the hollow body of the base, which includes the cylinder section 1 and rectangular section 2, and then come out from the two holes 4 and 5 on the bottom of the base as shown in FIG. 2 and FIG. 6. The two pins are then bent over against two outer opposite sides of the lower body 2 of the base.

When installing the LED bulb 6 into the base cylinder section 1, the anode pin 7 should be on the protrusion side, the cathode pin 8 should be on the other side as shown in FIG. 6.

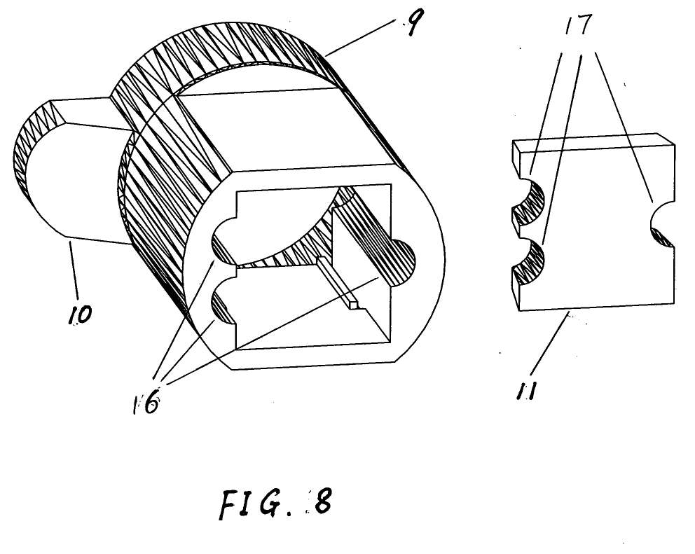

In FIG. 7, FIG. 8 and FIG. 11, a housing 10 is formed on the corner of a lateral side and the top side of a hollow and cylinder-shaped socket body 9. The top side of the housing 10 is open while the bottom side is closed. The size and shape of the housing 10 is well matched with the protrusion part 3 of a base 1.

As shown in FIG. 7, the top side and bottom side of a socket body 9 are open. There is a first pair of slots 14 and a second pair of slots 15 built on two opposite inner walls of a socket body 9. The top end of each slot is open while the bottom end of each slot is closed.

In FIG. 8, three vertical semicircular grooves 16 are formed on two sides of the socket inner wall. Three vertical semicircular grooves 17 are formed on two sides of a wedge 11. A wedge 11 can insert into the socket body 9 from its bottom side and thus close the bottom side of the socket body 9.

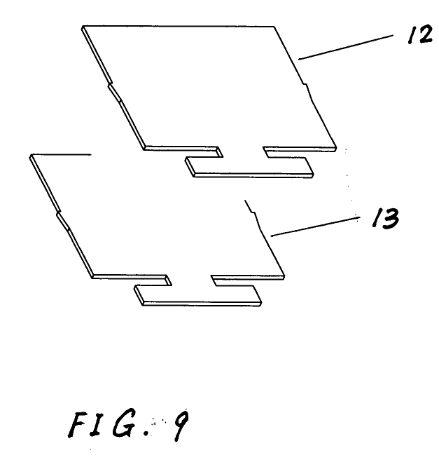

In FIG. 9, one or two electrical wires can be clamped by the lower part of the electrical terminal 12 and 13.

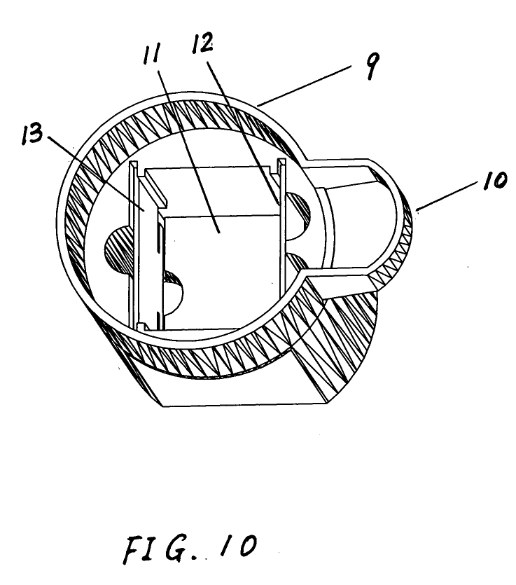

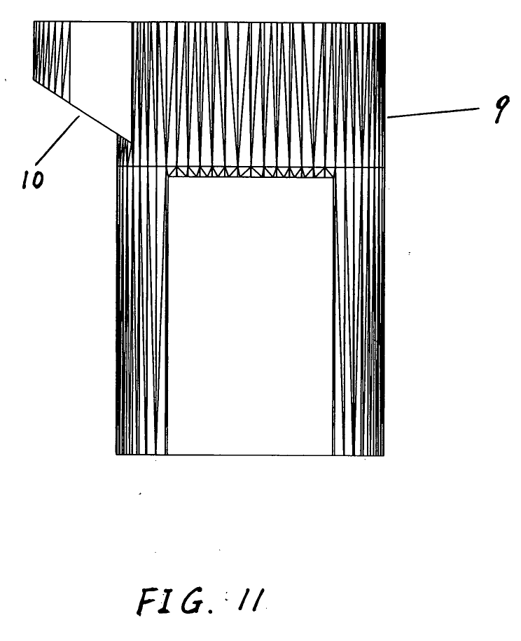

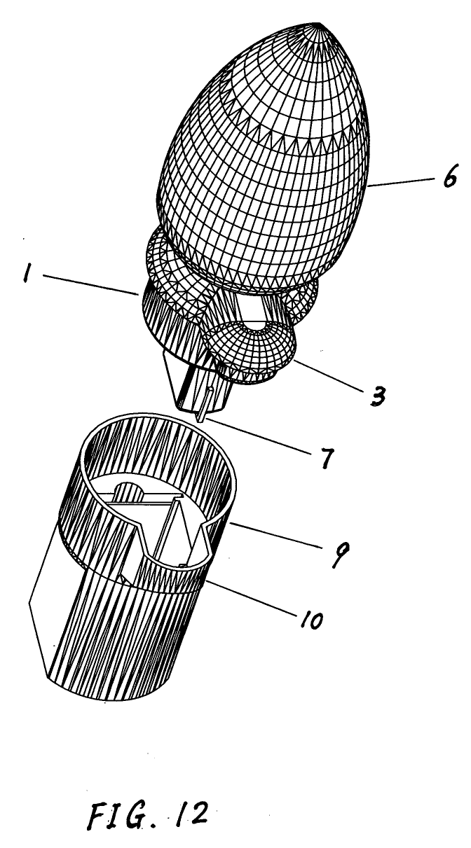

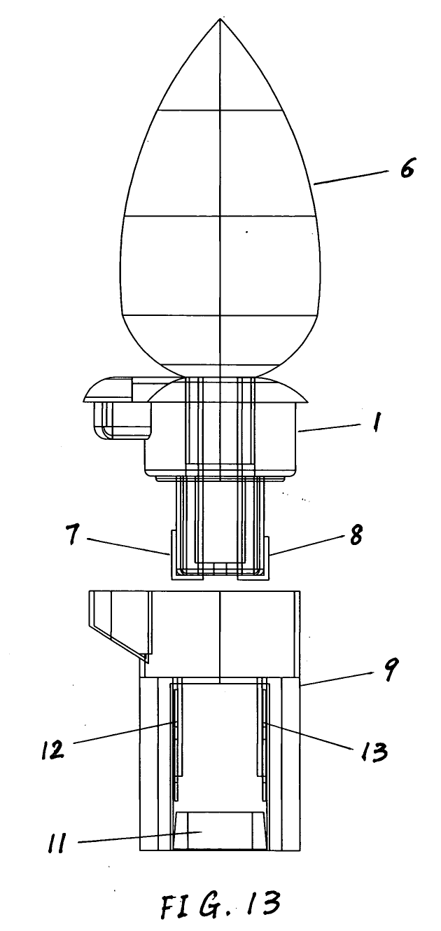

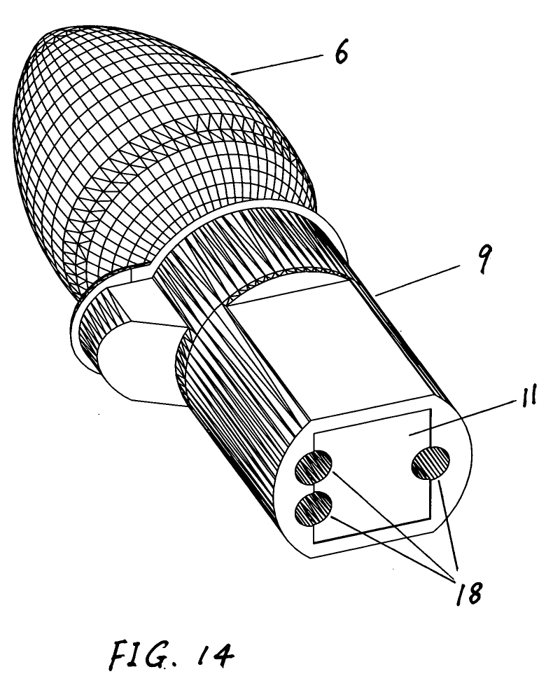

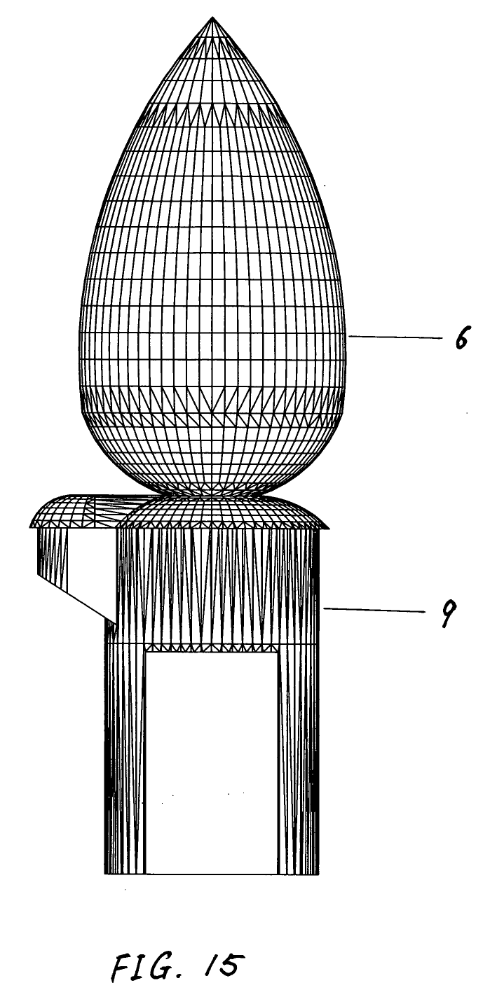

As shown in FIG. 7 and FIG. 10, the first electrical terminal 12 can insert into the first pair of slot 14, the second electrical terminal 13 can insert into the second pair of slot 15.

As shown in FIG. 12, an LED base 1 can insert into a socket 9 only when the protrusion 3 of the base and the housing 10 of a socket 9 are oriented in a same direction, where the housing 10 can houses the protrusion 3.

As shown in FIG. 13, after the LED base 1 inserts into the socket 9, LED pin 7 will firmly touch electrical terminal 12, LED pin 8 will firmly touch electrical terminal 13, thus a reliable electrical connection is established respectively between pin 7 and terminal 12, and between pin 8 and terminal 13.

As shown in FIG. 14, three circular holes 18 are formed when a wedge 11 is inserted into a socket body 9 from its bottom side. The three circular holes 18 are formed by three semicircular grooves 16 on the inner wall of a socket body 9 and three semicircular grooves on the sides of a wedge 11 as shown in FIG. 8. Electrical wires can pass through these circular holes.

What is claimed is:

1. A removable lampholder for an LED light bulb, comprising
a keyed LED base,
a socket,
two electrical terminals,
a wedge.

2. The said keyed LED base in claim 1 has a hollow body, wherein, there is a cylinder-shaped section as the base upper body for holding and fixing an LED light bulb, and a rectangular cube section as the base lower body. The base upper body and lower body are molded into a single body.

3. The base upper body in claim 2 has a protrusion built on the corner of one lateral side and the top side.

4. The base lower body in claim 2 has two small going-through holes on the flat bottom for passing two LED pins.

5. The said socket in claim 1 has a hollow cylinder-shaped body, wherein, the top side and the bottom side are open. A certain part of the socket upper body on the corner of one lateral side and the top side is extended outward, and thus forms a housing with its top side open and bottom side closed.

6. The keyed LED base and the socket in claim 1 are well matched in shape and size, where the LED base can insert into the socket from its top side only when the protrusion of the base and the housing of the socket are oriented in the same direction, and the housing of the socket houses the protrusion of the base.

7. The socket in claim 1 has 4 shallow vertical slots on its inner wall, with two slots forming a pair respectively. Each vertical slot is formed by a low ridge and a groove next to the ridge. The top end of each vertical slot is open, while the bottom end is closed.

8. The first slot pair in claim 7 is located on one side of the socket inner wall, while the second pair is located on the opposite side of the socket inner wall.

9. The said two electrical terminals in claim 1 are thin metal plates, wherein, there is a clamp portion on the lower part of each terminal for connecting one or two electrical wires. The first terminal can insert into the first pair of slot on one side of a socket inner wall as defined in claim 8, from the open top end and until it reaches the closed bottom end of the slots. The second terminal can insert into the second pair of slot on the other side of the socket inner wall as defined in claim 8, from the open top end and until it reaches the closed bottom end of the slots.

10. The said wedge in claim 1 is used to close the bottom side of the socket. The three vertical semicircular grooves carved on two sides of the wedge and the three vertical semicircular grooves carved on two inner sides of the socket lower body will form three circular holes when the wedge is installed in place. These holes will pass three electrical wires.
